(19) United States
(12) Patent Application Publication
(10) Pub. No.: US 2026/0099010 A1
(43) Pub. Date: Apr. 9, 2026

(54) COMPUTER CABLES HAVING CONNECTORS WITH CONFIGURABLE IDENTIFICATION UNITS

(71) Applicant: HEWLETT PACKARD ENTERPRISE DEVELOPMENT LP, Spring, TX (US)

(72) Inventors: Chien-Jen Chen, Taoyuan City (TW); Chi-Ting Yang, New Taipei City (TW); Yi-Hsuan Wu, Taipei City (TW)

(21) Appl. No.: 18/909,332

(22) Filed: Oct. 8, 2024

(51) Int. Cl. G02B 6/38; H01R 13/645; H01R 43/26

(52) U.S. Cl. CPC G02B 6/3895; H01R 13/645; H01R 43/26

(57) ABSTRACT

A computer cable may include a wire assembly and connectors coupled to opposite ends of the wire assembly. Each connector may include a connector housing, a set of pins held by the connector housing and coupled with the wire assembly, and an identification unit formed in part by the connector housing. The identification unit may include a set of identifiers formed on or in the connector housing and a movable indicator movably coupled to the connector housing. The indicator may be configured to be movable relative to the connector housing to selectively visually indicate any identifier of the set of identifiers. The identification units may indicate to a user assembling or servicing a computer system how the connectors of the computer cable should be connected to connectors of the computer system.

### INTRODUCTION

Information processing systems, such as servers and networking devices, often utilize electronic or optical cables to communicably connect components of the system together to allow the transfer of data and/or electrical power therebetween. For example, computer cables are often utilized to communicably connect peripheral components of an information processing system to a primary system board (e.g., motherboard) of the system. Such cables may be referred to herein as computer cables. A computer cable generally comprises two connectors, one at each end of the cable, and a wire assembly comprising a collection of one or more electrical wires or optical fibers extending between the two connectors. Each connector of the cable is configured to mate with a complementary connector of a component to establish an electrical or optical connection therewith.

### BRIEF DESCRIPTION OF THE DRAWINGS

The present disclosure can be understood from the following detailed description, either alone or together with the accompanying drawings. The drawings are included to provide a further understanding of the present disclosure and are incorporated in and constitute a part of this specification. The drawings illustrate one or more examples of the present teachings and together with the description explain certain principles and operations. In the drawings:

FIG. 1 is a block diagram illustrating an example cable for use in an information processing system.

FIG. 2 is a block diagram illustrating a computing system comprising the cable of FIG. 1.

FIG. 3 is a perspective view of an example cable.

FIG. 4 is a top view of the cable of FIG. 3.

FIG. 5 is a perspective exploded view of the cable of FIG. 3.

FIG. 6 is a top view of the cable of FIG. 3 with a cover portion omitted and showing a first state.

FIG. 7 is a top view of the cable of FIG. 3 with the cover portion omitted and showing a second state.

FIG. 8 is a perspective view of another example cable.

FIG. 9 is a front perspective view of an example identification unit for yet another cable.

FIG. 10 is a rear perspective view of the identification unit of FIG. 9.

### DETAILED DESCRIPTION

As mentioned above, peripheral components are often connected to the system board, directly or indirectly, via computer cables which mate with connectors on the system board. Often there are multiple such peripheral components, and therefore a system may comprise multiple cables to connect these components to the system board.

In some circumstances, certain peripheral components need to be connected to specific corresponding connectors of the system board. For example, suppose that a system has one or more drive cages configured to removably receive storage drives. Furthermore, suppose that these drive cages have one or more backplanes which have multiple backplane connectors which are to be connected to a system board via cables. In some circumstances, it may be required or desired that a first backplane connector be connected to a first specific connector on the system board, a second backplane connector be connected to a second specific connector on the system board, and so on. By connecting the backplane connectors to specific designated system board connectors in this manner, the system may be able to deduce the locations of storage drives installed in the drive cages based on which connectors are receiving signals from those storage drives. However, if the cables were instead connected to arbitrary combinations of backplane connectors and system board connectors, without taking care to ensure the backplane connectors are connected to their respectively designated system board connectors, the system might not be able to deduce where the storage drives are located. Thus, for this and many other reasons, it may be desired in some circumstances for certain peripheral component connectors to be connected to specific corresponding system board connectors.

However, it can often be difficult for someone assembling a system, or servicing (repairing, upgrading, etc.) a previously assembled system, to know how the computer cables should be connected. Often, the system board has multiple connectors which look similar (e.g., they may have the same form factor), and thus there might not be any immediate visual cues to help the user distinguish or identify the system board connectors. Furthermore, the correspondence between peripheral connectors and system board connectors does not always intuitively match the physical layout of the connectors, and it may also vary from one system to another. Consequently, it may not always be apparent to the assembly or service personnel which system board connector corresponds to which peripheral component connector.

Furthermore, even if the assembly or service personnel know which peripheral component connector is supposed to be connected to which system board connector, it can sometimes still be difficult for the personnel to properly connect the cables. This difficulty may arise because there are often multiple cables in the system and these cables are often routed together through the system in a group or bundle, and therefore it may not be immediately apparent which connector at one end of the cable bundle is connected to which connector at the other end of the cable bundle. Thus, for example, even if an assembly or service person knows that backplane connector 1 is supposed to be connected to system board connector 2 and that a given connector at one end of a bundle of cables is connected to backplane connector 1, the person may not know which connector at the other end of the bundle to plug into system board connector 2 because they do not know which connector at that other end is connected to the given connector. In some cases, it is possible for the assembly or service personnel to figure out which connectors at one end of the cables are connected to which connectors at the other end, for example by manually tracing the wires coupled thereto back to the other end, but this takes additional time and effort and creates the potential for error. Furthermore, in some cases, the ability for the person to trace the wires in this manner may be hindered by obstructions or by a protective sheath which encompasses a bundle of cables.

To address these and other issues, disclosed herein are computer cables whose connectors each have integrated therein an identification unit which visually indicates to a user an identifier for the connector. Moreover, the identification unit is reconfigurable such that the identifier indicated by the identification unit can be changed by a user between multiple predetermined identifiers. In other words, the identifier is not fixed at the time of manufacture, but can be set or reset to any of multiple possible values post-manufacture. For example, the identification unit may include visual representations of multiple predetermined identifiers, such as characters (numbers, letters, etc.), symbols, colors, etc., arranged in a row and a slidable indicator arranged to indicate (e.g., point to, surround, etc.) one of the indicators. The slidable indicator can be physically moved by the user to different positions to indicate any one of the predetermined identifiers. The identification units of the connectors can be used to indicate to a person assembling or servicing a system which connectors of the cables should be connected to which peripheral component connectors and to which system board connectors.

The identification units of the connectors can be used in a variety of ways to address the challenges noted above. For example, in one technique, each cable connector may have its identification unit configured to indicate an identifier that matches an identifier of the peripheral component connector or system board connector that the cable connector is supposed to mate with. For example, suppose that a system has backplane connectors numbered 1 and 2 and system board connectors numbered 3 and 4. And suppose further that backplane connector 1 is supposed to be connected to system board connector 4. In that case, prior to assembly of the information processing system, one of the cables disclosed herein may be configured such that the identification unit of one of the cable connectors thereof is set to indicate “1” and the identification unit of the other cable connector thereof indicates “4”. This would allow the person assembling or servicing the system to easily discern that the cable connector with identifier “1” is to be plugged into backplane connector 1 and the cable connector with identifier “4” is to be plugged into system board connector 4. Similarly, another cable could have its identifiers set to “2” and “3”, indicating to the assembly or service person that its connectors are to be connected to backplane connector 2 and system board connector 3. (In the mentioned example, the peripheral component connectors and the system board connectors have different identifiers, but this is just one example and in other examples the same identifiers could be used for the peripheral and system board connectors.) In this manner, the identification units may directly indicate to the user which peripheral component connector or which system board connector that each cable connector is to be connected to.

As another example, in a second technique, the identifiers of the cable connectors do not necessarily directly indicate which connectors to connect to but may instead indicate which cable the connectors are part of, which information can be used by the person assembling the system to determine which connectors to connect to. For example, prior to assembly of the system, each cable may be configured such that the two connectors thereof are set to the same identifier as one another, with each cable having a different identifier than the others. For example, a first cable may have its two connectors set to “A”, a second cable may have its two connectors set to “B”, and so on. Consequently, even if the cables all become bundled together, a person assembling or servicing a system can still easily determine which connector at one end of the bundle is connected to which connector at the other end of the bundle—i.e., the person can infer that a connector labeled “A” at one end of the bundle is connected to a connector labeled “A”at the other end of the bundle, and so on.

Thus, the identifiers on the cable connectors can make it easier for assembly or service personnel to figure out how the cables should be connected to the peripheral components and to the system board connectors.

Moreover, the ability to configure and reconfigure the identification units of the connectors to indicate a variety of identifiers has various benefits relative to alternative approaches.

For example, in one alternative approach, cables may have specific identifiers added thereto which are fixed at the time of manufacture of the cable, with multiple different versions of the cables being manufactured having different combinations of identifiers. For example, a different identifying character may be formed into each connector housing (e.g., via injection molding), or connectors may be formed with different colors (with the color serving as the identifier), or labels may be affixed to the connectors, etc. However, in this alternative approach, because there are multiple different versions of the cables which have different fixed identifiers, manufacturing and logistical costs and complexity may be increased. The costs of manufacturing the cables may be increased because the different fixed identifiers may require physically different cable connectors to be produced, which may require separate manufacturing equipment or lines. For example, if an identifying character is to be integrally formed into an injection molded connector housing, then different injection molds will be needed for each connector. As another example, if connectors are to have different colors as their identifiers, then different dyes or other coloring agents may be needed and, in some cases, different manufacturing lines may be needed for each color of connector. Furthermore, having multiple different types of cables with different identifiers increases logistical costs and complexity, as each different cable may require its own parts number or stock-keeping unit (SKU) and the cables may need to be sorted and warehoused accordingly.

In contrast, in examples disclosed herein, a single type of computer cable can be used instead of the multiple versions of cables which would be required in the alternative approach. A single computer cable can replace the multiple versions of cables because the single cable can be selectively configured, post-manufacture, by moving the sliding indicators, so that its connectors indicate any of multiple predetermined identifiers. Although the example cables can be reconfigured to indicate different identifiers, they all have the exact same structure as one another at the time of manufacture, accordingly, only one set of manufacturing equipment may be needed to produce the connectors, and only one parts number or SKU may be needed for all of the cables, which greatly reduced manufacturing and logistical costs.

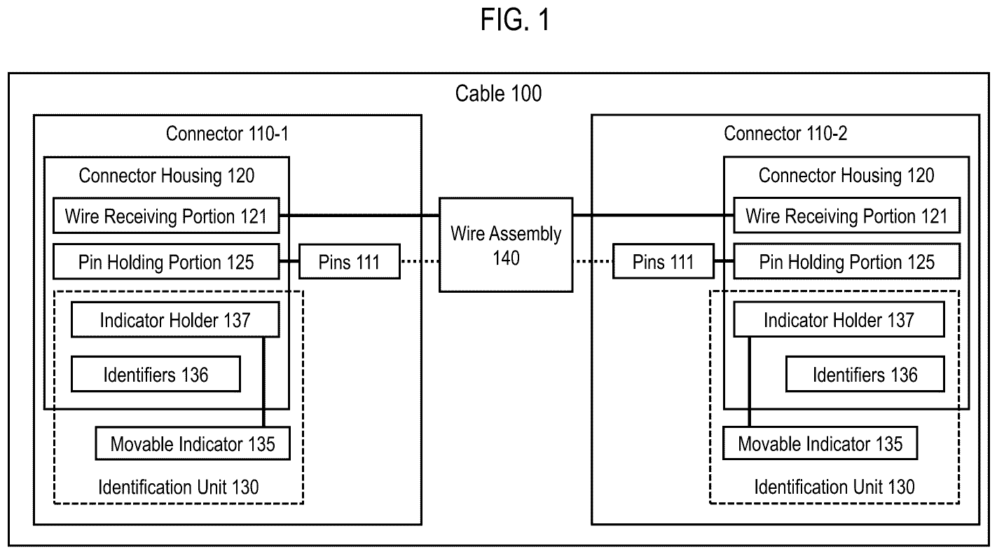

These and other examples will be described in greater detail below in relation to FIGS. 1-10.

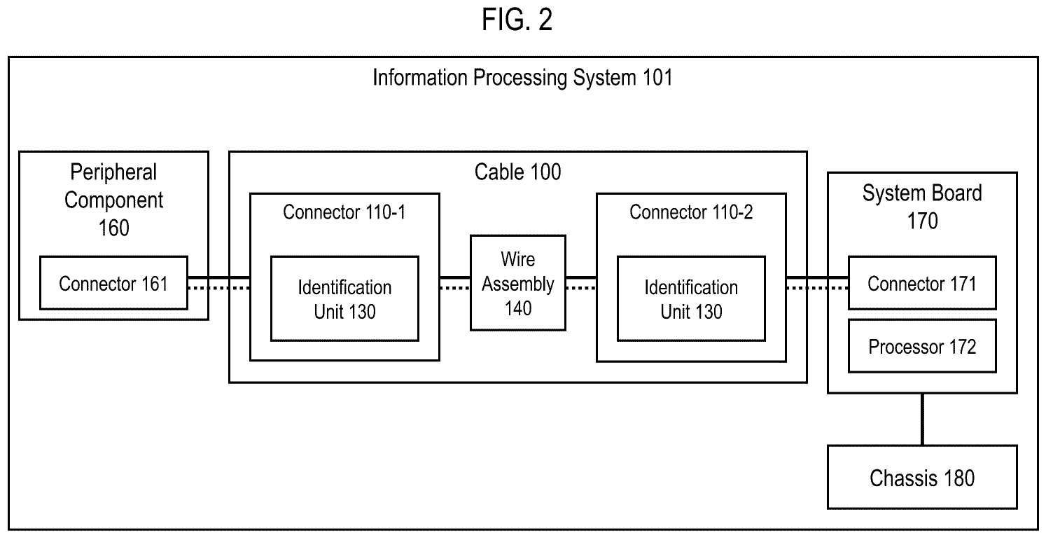

FIG. 1 illustrates an example computer cable 100 and FIG. 2 illustrates an example information processing system 101 which comprises the computer cable 100. FIGS. 1 and 2 are schematic in nature and are not intended to illustrate shapes, sizes, or other structural details accurately or to scale. Components which are not illustrated in FIGS. 1 and 2 may also be included in some examples disclosed herein, or one or more components illustrated in FIGS. 1 and 2 may be omitted from some examples disclosed herein. In FIGS. 1 and 2, solid lines extending between blocks indicate physical engagement or attachment between the components represented by the blocks, whereas dotted lines extending between blocks indicate electrical or optical connections between the components represented by the blocks.

As shown in FIG. 1, the cable 100 comprises two connectors 110-1 and 110-2 (collectively connectors 110) connected together by a wire assembly 140. The connectors 110 are each configured to mate with complementary connectors of components of an information processing system (such as system 101, described below). The wire assembly 140 comprises one or more wires or optical fibers which extend between and are electrically or optically connected to or coupled with the connectors 110 so as to form one or more communication paths between the connectors 110 over which electrical and/or optical signals can be communicated. Thus, when the two connectors 110 are mated with complementary connectors of two components of an information processing system, the cable 100 communicably connects those two components together.

In some examples, each of the connectors 110 may have the same structure, and thus the description below will focus primarily on one of the connectors 110. Each connector 110 comprises a connector housing 120, a number of pins 111 disposed in or coupled (directly or indirectly) to the connector housing 120, and an identification unit 130.

The connector housing 120 includes a wire receiving portion 121 which is configured to receive one end of the wires or optical fibers of the wire assembly 140 and a pin holding portion 125 which holds pins 111. These two portions 121 and 125 may be two portions of the same integrally connected (monolithic) body, or they may be two separate bodies which have been attached together. In some examples, the wires or fibers of the wire assembly 140 extend into an internal chamber inside connector housing 120 via an opening in the wire receiving portion 121, and the wires or optical fibers are electrically connected or optically coupled to the pins 111 inside this internal chamber. In some examples, the wires or optical fibers are physically attached to the wire receiving portion 121—for example, the wire receiving portion may be insert-molded around the wires or fibers, or adhesives (e.g., epoxy) may be used to attach the wires or fibers to the wire receiving portion 121, or some other fastening technique may be used. In other examples, the wires or optical fibers are attached to the connector 110 solely through their connection to the pins 111 (described below), without having a separate physical attachment to the connector housing 120.

As noted above, the pin holding portion 125 holds the pins 111. The pins 111 may be electrical terminations or optical terminations which are configured to removably engage, couple, or otherwise interact with complementary pins of another connector when the connector 110 is mated thereto and to thereby exchange electrical or optical signals with the complementary pins. These electrical or optical terminations are referred to herein as “pins” for convenience, but this reference is not intended to limit their physical structure. In examples in which the pins 111 are electrical terminations, they may be any sort of electrical termination capable of making removable electronic connections with the complementary pins, such as an electrical contact pad, an electrical spring finger, a socket- or jack-style electrical termination, a columnar- or plug-style electrical termination, etc. In examples in which the pins 111 are optical terminations, they may be any sort of optical termination capable of making removable optical connections with complementary pins, such as the ends of the optical fibers, an optical lens, an optical multiplexer, etc. In some examples, the pins are physically attached directly to the pin holding portion 125. In other examples, the pins 111 are attached to an intermediate part, such as a printed circuit board (PCB), which is in turn attached to the pin holding portion 125. The pin holding portion 125 may be insert-molded around the pins 111 or the intermediate part (e.g., PCB), or adhesives (e.g., epoxy) may be used to attach the pins 111 or intermediate part to the pin holding portion 125, or some other fastening technique may be used.

Each connector 110 also comprises an identification unit 130, at least part of which is formed as part of the connector housing 120. Specifically, the identification unit 130 comprises a set of identifiers 136, a movable indicator 135, and an indicator holder 137, with at least the indicator holder 137 being formed as part of the connector housing 120.

The indicator holder 137 is configured to hold the movable indicator 135. In some examples, the indicator holder 137 comprises a channel or recess in which the indicator 135 may be disposed, together with one or more retention features which engage the indicator 135 to constrain its motion and hold it in place in the connector housing 120.

The movable indicator 135 may be a part which is distinct from the connector housing 120 and which is movably coupled thereto via the indicator holder 137. The movable indicator 135 may be configured to move along an axis of motion, for example by sliding relative to the connector housing 120. In some examples, the movable indicator 135 may be constrained to motion only along the axis of motion.

The identifiers 136 comprise visual representations of a plurality of predetermined identifiers, which may include characters (numbers, letters, etc.), symbols, colors, or other visual identifiers. In some examples, the identifiers 136 are part of the connector housing 120, meaning that the identifiers 136 are either integrally formed in the connector housing 120 (i.e., formed as part of the same unitary or monolithic body) or are permanently attached thereto. (Permanent, in this context, refers to a connection which is not designed for routine or easy reversal, such as a connection which would require application of destructive means to reverse). The identifiers 136 may be formed in or attached to the connector housing 120 on or adjacent to the indicator holder 137, with the identifiers 136 being arranged in a row (in a line) which extends generally parallel to the axis of motion of the movable indicator 135. Thus, the movable indicator 135 held by the indicator holder 137 can be selectively positioned adjacent to any one of the identifiers 136.

The movable indicator 135 is configured to visually indicate the one of the identifiers 136. Specifically, by moving the movable indicator 135 along its axis of motion, the indicator 134 can be positioned adjacent to any one of the plurality of identifiers 136, and the indicator 135 may be configured to indicate whichever one of the identifiers 136 the indicator 135 happens to be adjacent. In some examples, the movable indicator 135 comprises a window which is configured to surround (e.g., encircle, frame) the identifier 136 which is adjacent to the indicator 135, in which case the identifier 136 being indicated by the indicator 135 may be understood as being the identifier 136 surrounded by the window. In some examples, the movable indicator 135 comprises a pointer or alignment mark (e.g., arrow, point, triangle, dot, line, or other visual cue) which is configured to point to or align with the identifier 136 which is adjacent to the indicator 135, in which case the identifier 136 being indicated by the indicator 135 may be understood as being the identifier 136 pointed to by or aligned with the pointer or alignment mark. In some examples, the indicator 135 may lack specific indication features such as the window or pointer and instead the identifier 136 being indicated by the indicator 135 may be understood as simply being the identifier 136 which is adjacent to (e.g., closest to) the indicator 135.

In some examples, the indicator holder 137 has a plurality of stops which define a plurality of predetermined positions at which the indicator 135 may be positioned along the axis of motion. In some examples, the indicator 135 and/or the indicator holder 137 may be flexible such that the indicator 135 can move over the stops when a user supplies sufficient force thereto but the stops can hold the indicator 135 in the predetermined position in the absence of such an externally applied force.

As shown in FIG. 2, in some examples, the computer cable 100 may be deployed as part of an information processing system 101. The information processing system 101 may be, for example, a server, a networking device, or any other information processing system. The system 101 comprises a chassis 180, a system board 170 and a peripheral component 160 and the cable 100 may be used to interconnect these components.

The chassis 180 comprises one or more support structures, such as a base, side walls, front panel, rear panel, cover, drive cages, etc. The chassis 180 supports and/or houses the system board 170.

The system board 170 has various electronic components mounted thereto, including a processor 172 among other components. The processor 105 may be any information processing resource, such as a central processing unit (CPU), a graphical processing unit (GPU), a system-on-chip (SoC), an application-specific integrated circuit (ASIC), or any other hardware capable of processing machine readable information. The system board 170 also comprise one or more connectors 171 mounted thereto.

The peripheral component 160 may include an electrical component which is part of the system 101 but which is not directly mounted to the system board 170, such as a removable storage drive (e.g., Hard Disk Drive (HDD), Solid State Drive (SSD), etc.), a network interface card (NIC), a host bus adaptor (HBA), a backplane or midplane, or other peripheral component. The peripheral component 160 comprises a connector 161.

As shown in FIG. 2, in some examples, connector 110-1 of cable 100 may be connected to the connector 161 of the peripheral component 160 while connector 110-2 of cable 100 is connected to the connector 171 of the system board 170, thereby communicably connecting the peripheral component 160 to the system board 170.

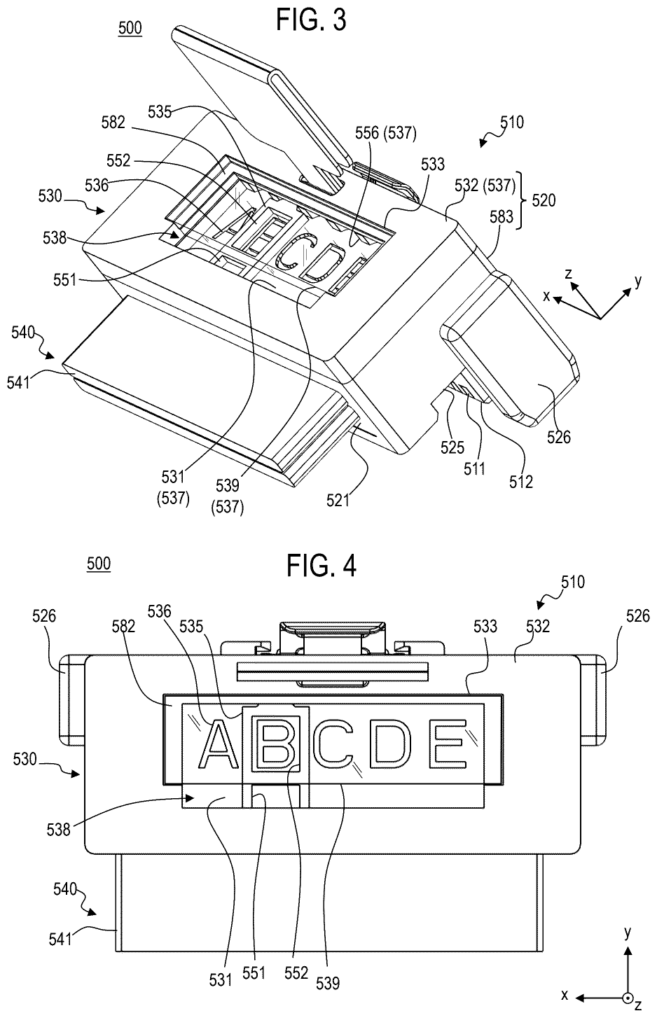

Turning to FIGS. 3-7, a cable 500 will be described. The cable 500 is an implementation example of the cable 100. Accordingly, the cable 500 comprises components which correspond to (i.e., are implementation examples of) components of the cable 100 which were described above. Components of the cable 500 which correspond to components of the cable 100 will be given similar reference numbers herein, such as 110 and 510.

As shown in FIG. 3, the cable 500 comprises a wire assembly 540 and a connector 510 coupled to one end of the wire assembly 540. Only a portion of wire assembly 540 is illustrated. Cable 500 may also comprise another connector (not illustrated) connected to an opposite end (not illustrated) of the wire assembly 540. In some examples, this other connector may be identical in structure to the connector 510. In other examples, the other connector may be different from the connector 510.

The wire assembly 540 comprises a collection of electrical wires 541. The wires 541 may be bundled together and may have individual and/or shared protective sheathing. The electrical wires 541 are electrically connected, e.g., soldered, to a printed circuit board (PCB) 512 of the connector 510. The PCB 512 carries pins 511 in the form of edge-connector style electrical contact pads (sometimes called “gold fingers”) at an edge of the PCB 512, and these pins 511 are electrically connected to the electrical wires 541 via the PCB 512 (e.g., the wires 541 may be soldered to landing pads (not illustrated) which are, in turn, electrically connected to the pins 511 via conductive traces in the PCB 512).

The connector 510 comprises a connector housing 520 and the aforementioned PCB 512 retained by the connector housing 520. The connector housing 520 is one example implementation of the connector housing 120, and comprises a wire receiving portion 521, a pin holding portion 525, anti-skew features 526, and a cover portion 532.

As shown in FIG. 3, the wire receiving portion 521, the pin holding portion 525, and anti-skew features 526 form a base 583 to which the cover portion 532 is attached. In some examples, the base 583 is a unitary (monolithic) body, i.e., the wire receiving portion 521, the pin holding portion 525, and anti-skew features 526 are integrally connected. In some examples, the cover portion 532 is attached to the base 583 by adhesives, by heat staking, by welding, by friction fitment, by mechanical fasteners, or by other fastening mechanism. In some examples, the base 583 and/or the cover portion 532 is/are formed by molding (e.g., injection molding) or additive manufacturing (e.g., 3D printing). In some examples, the base 583 and/or the cover portion 532 is/are formed from a plastic.

The wire receiving portion 521 comprises an opening through which the wires 541 are received into an internal cavity inside the connector housing 520. The internal cavity may extend from the opening in the wire receiving portion to another opening in the pin holding portion 525. The wires 541 may extend through this internal cavity until they terminate at the PCB 512. In some examples, a proximal portion of the PCB 512 may also extend into the internal cavity in the pin holding portion 525. The wire receiving portion 521 may physically secure/attach the wires 541 to the connector 510, in addition to attachment provided by the electrical connection. For example, wire receiving portion 521 may be insert-molded onto the electrical wires 541, or epoxy or other adhesives may be used to attach wires 541 to wire receiving portion 521, or friction attachment or other fastening mechanisms may be used to attach wires 541 to wire receiving portion 521. Similarly, the pin holding portion 525 may physically secure/attach the PCB 512 to the connector 510. For example, pin holding portion 525 may be insert-molded onto the PCB 512, or epoxy or other adhesives may be used to PCB 512 to pin holding portion 525, or friction attachment or other fastening mechanisms may be used to attach PCB 512 to pin holding portion 525. In some examples, wires 541 are first electrically connected (e.g., soldered) to PCB 512, and then the base 583 of connector 510 may be formed by insert-molding around the assembly of the wires 541 and PCB 512.

The connector 510 also comprises an identification unit 530, which is an example implementation of the identification unit 130. The identification unit 530 comprises identifiers 536, a movable indicator 535, and an indicator holder 537. The indicator holder 537 is made up of multiple parts which work together to hold the indicator 535, including: the cover portion 532, an identifier carrying surface 531, a transparent windowpane 539, and a guide frame 556. These components of the identification unit 530 will be described in turn below.

The identifiers 536 comprise visual representations of characters which are arranged in a recessed cavity in the connector housing 520 in such a manner as to be visible to a user from a perspective above the connector 510 (i.e., higher along the z-axis). As shown in FIGS. 3-5, the recessed cavity is formed by an aperture 533 which extends through the cover 532 and by an identifier carrying surface 531 of the base 583. The lateral walls of the cover 532 within the aperture 533 define lateral bounds of the cavity while the surface 531 defines a bottom bound of the cavity. The identifiers 536 are formed in or on the identifier carrying surface 531. In the illustrated example, the aperture 533 has a generally rectangular profile, but in other examples it may have any other shape. In some examples, the top side of the cavity is partially closed by a transparent windowpane 539 which sits within the aperture 533 on a ledge 582 formed therein (see FIGS. 3-5). The windowpane 539 can protect the identifiers 536 and indicator 535 while still allowing the identifiers 536 to be seen. In some examples, the windowpane 539 may be omitted.

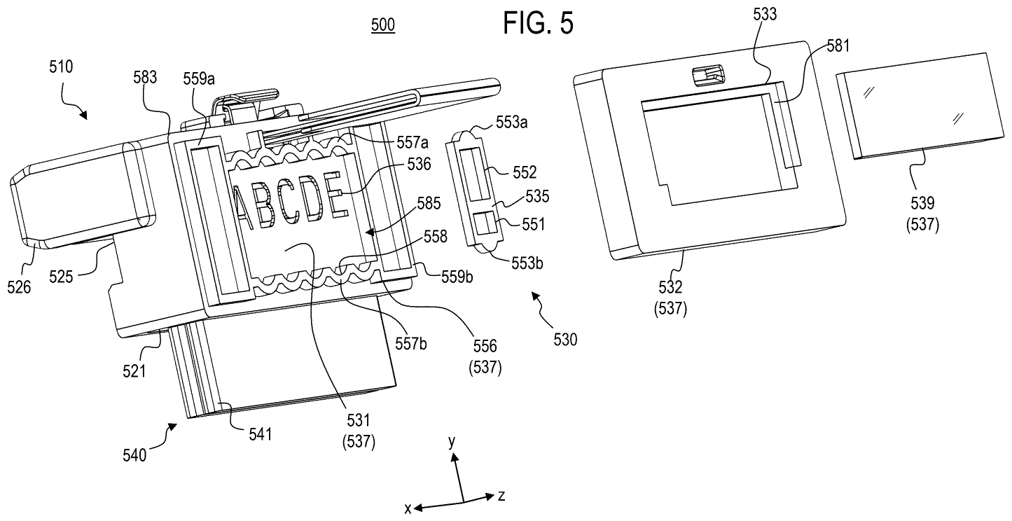

In the illustrated example, the identifiers 536 comprise the capital Roman letters A, B, C, D, and E. As shown in FIG. 5, the identifier carrying surface 531 corresponds to a top surface of the base 583. The identifiers 536 are arranged in a line or row at predetermined locations which correspond to predetermined locations of the indicator 535. In the illustrated example, the identifiers 536 are formed as a series of recesses which form segments of the characters, with the recesses being recessed relative to the surrounding flat portions of the surface 531. This configuration in which the identifiers 536 are formed by recesses may be referred to herein an “engraved configuration.” Note that “engraved” when used herein refers only to the phenomenon of the identifiers 536 having recessed structures as described, but this term is not intended to imply any limitation on the manner in which these structures are formed. More specifically, although engraving may sometimes refer, in other contexts, to forming designs specifically by removing material from a surface, such as by carving, the usage of the term “engraved” herein does not imply or require such removal of material. Instead, the engraved configuration of the identifiers 536 may be achieved through any of a variety of methods, some of which may entail removal of material and others which do not. For example, the identifiers 536 with the engraved configuration may be formed: (1) by the removal of material from a previously-formed surface 531, such as through carving, milling, abrasive treatment (e.g., sandblasting), laser ablation, etc. (2) as an integral feature of the surface 531 during an injection molding process which forms the base 583, (3) as an integral feature of the surface 531 during an additive manufacturing process which forms the base 583, or (4) by any other method.

The movable indicator 535 is positioned in the aforementioned cavity on the surface 531 above the identifiers 536. As best seen in FIG. 5, the movable indicator 535 comprises a generally rectangular frame which has an indicator window 552 in a middle/top portion thereof, a tool opening 551 in a bottom portion thereof, and stop-engaging protrusions 553a and 553b protruding from the top and bottom, respectively, thereof.

As shown in FIG. 4, the indicator window 552 is configured to surround or frame an identifier 536 when the movable indicator 535 is positioned adjacent thereto. In this manner, the indicator 535 visually indicates whichever identifier 536 is currently surrounded by the indicator window 552.

The tool opening 551 is configured to receive a tip of a tool, such as a screwdriver, paper clip, or other tool. A user may then move the tool laterally, which causes the tool to push against the movable indicator 535 and thereby move the indicator 535 laterally, as will be discussed in more detail below. The tool may be inserted into the tool opening 551 via a slot 538, visible in FIGS. 3 and 4, which will be described below.

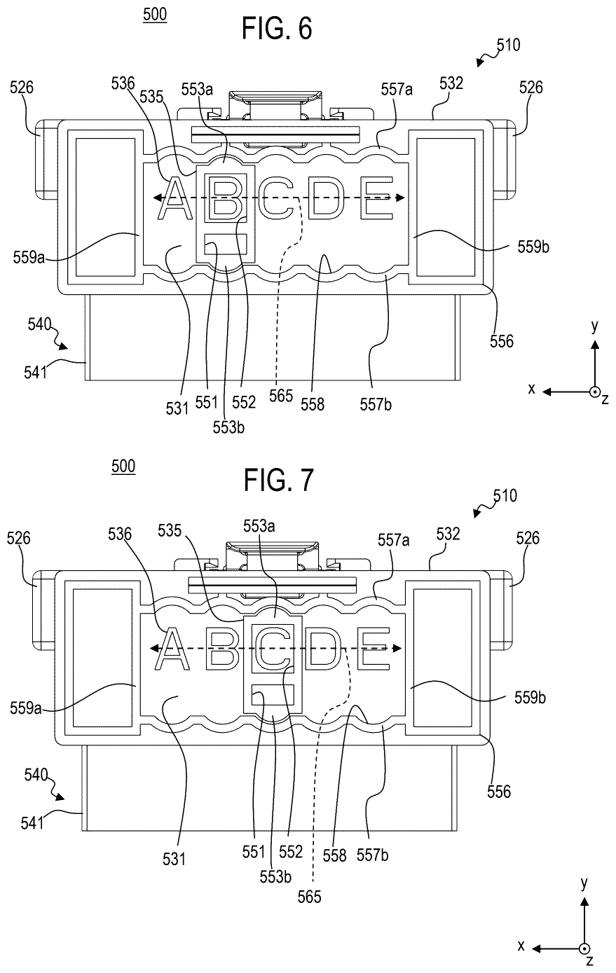

The stop-engaging protrusions 553a and 553b are configured to engage with stops 558 (see FIGS. 6 and 7) to control a position of the indicator 535, as will be described below.

As previously mentioned, the indicator holder 537 is made up of various parts which hold the indicator 535, including the cover portion 532 and the identifier carrying surface 531. As shown in FIGS. 3-7, the identifier carrying surface 531 is positioned below the indicator 535, and as shown in FIGS. 3-5, portions of the cover 532 are positioned above the indicator 535, such that the indicator 535 is sandwiched between the surface 531 and the cover 532. In this manner, the indicator 535 is contained or held between the surface 531 and the cover 532, with the surface 531 and the cover 532 constraining motion of the indicator 535 to allow substantially only motion in a plane parallel to the surface 531 (e.g., a plane parallel to the x-y plane). The transparent windowpane 539 is also positioned above the indicator 535, as shown in FIGS. 3-5, and can also aid the cover 532 in constraining the motion of the indicator 535 (although in some examples, the windowpane 539 is omitted). A slot 538 may be formed between the windowpane 539 and a bottom edge of the aperture 533 through which a tool may be inserted into the tool opening 551.

The indicator holder 537 also comprises a guide frame 556, which is most easily seen in FIGS. 5-7. The guide frame 556 includes two side portions 559 (left side portion 559a and right side portion 559b) and two cross-members 557 (top cross-member 557a and bottom cross-member 557b) which are each connected to and extend between the two side portions 559 to define a central window 585 of the guide frame 556. The guide frame 556 is positioned between the surface 531 and the cover 532, with the central window 585 thereof positioned over the identifiers 536 such that the identifiers 536 are visible through the window 585. The indicator 535 is also disposed within the window 585, as shown in FIGS. 6 and 7, such that the two side portions 559 and cross-members 557 further constrain motion of the indicator 535. The cross-members 557 prevent motion of the indicator 535 along the y-axis in the figures. Thus, the indicator holder 537 holds the indicator 535 and constrains its motion while allowing the indicator 535 to be moved along an axis of motion 565, which is parallel to the x-axis in the figures.

In the example of FIGS. 3-7, the cross-members 557 also comprise a number of stops 558. These stops 558 are configured to engage with the stop-engaging protrusions 553 of the indicator 535 to force the indicator 535 to come to rest in certain predetermined positions along the axis of motion 565 instead of allowing the indicator 535 to be positioned at any arbitrary position along the axis 565. Each of these predetermined positions corresponds to one of the identifiers 536, such that when the indicator 535 is in a given predetermined position it is aligned with and indicates the corresponding identifier 536. Moreover, each predetermined position corresponds to two of the stops 558, one in the top cross-member 557a and one directly opposite therefrom in the bottom cross-member 557b. Thus, when the indicator 535 is in a given predetermined position, the two stop-engaging protrusions 553a and 553b thereof are received within the two stops 558 which correspond to the position, with the protrusion 553a engaged with the corresponding stop 558 in the top cross-member 557a and the protrusion 553b engaged with the corresponding stop 558 in the bottom cross-member 557b. For example, in FIG. 6, the indicator 535 is in a predetermined position corresponding to the “B” identifier 536 and the stop-engaging protrusions 553a and 553b thereof are engaged with the two stops 558 associated with this position, whereas in FIG. 7, the indicator 535 is in a predetermined position corresponding to the “C” identifier 536 and the stop-engaging protrusions 553a and 553b thereof are engaged with the two stops 558 associated with this position.

In this example, the stops 558 comprise recesses defined by concave curved surfaces (aka “scallops”) and the stop-engaging protrusions 553 comprise convex curved surfaces which are complementary to the stops 558. When the stops 558 are engaged with the protrusions 553, portions of the concave surface of the stops 558 laterally abut portions of the convex surface of the protrusions 553, and contact between these portions resist movement of the indicator 535 along the axis of motion 565. This resistance to motion of the indicator 535 tends to hold the indicator 535 in the predetermined position. This can help to avoid inadvertent movement of the indicator 535, such as might occur due to shock, vibration, gravity, or the like.

However, while the stops 558 resist motion of the indicator 535, they do not rigidly prevent such motion. Instead, the stops 558 merely require that a threshold amount of force be supplied to the indicator 535 in order to allow the indicator 535 to be moved. If sufficient force is applied, for example by a user inserting a tool into the tool opening 551 and pushing against the indicator 535, then the indicator 535 and/or the cross-members 557 may elastically deform (flex) sufficiently to allow the protrusions 553 to move along the axis 565 past the stops 558. For example, in some implementations the cross-members 557a and 557b are not directly attached to the surface 531 and thus are free to flex outwardly (in +/−y directions) to allow the protrusions 553 to move past the stops 558. As another example, in some implementations the indicator 535 may be configured to deform inwardly (in +/−y directions) to allow the protrusions 553 to move past the stops 558. In some examples, both indicator 535 and cross-members 557 can flex. The internal spring forces of the indicator 535 and/or cross-members 557 resist the deformation of these parts, and thus the force supplied by the user to move the indicator 535 may need to exceed the spring forces in order to move the indicator 535 out of a predetermined position. The spring force may be sufficiently high to avoid inadvertent movement (e.g., due to shock/vibration) but also low enough that a user is able to overcome it when desired to move the indicator 535.

When the indicator 535 is at an intermediate position between the predetermined positions, the indicator 535 and/or cross-members 557 are in a deformed state and thus they generate spring forces which urge the parts to return to their resting position. If the user does not supply external forces to counteract the restoring spring forces, the spring forces will push the indicator 535 and cross-members 557 against one another and the engagement of the curved surfaces of the stops 558 and protrusions 553 will transform this pushing into lateral forces that urge the indicator 535 to move along the axis 565 towards the nearest predetermined position. Once the indicator 535 has moved into the predetermined position, the spring forces disappear and thus the indicator 535 comes to rest in the predetermined position. In other words, the stops 558 define a set of stable positions at which the indicator 535 can come to rest, whereas other intermediate positions will be unstable and the indicator 535 will tend to be pushed out of the unstable positions and into an adjacent stable predetermined positions. Thus, as the indicator 535 is moved along the axis of motion 565 by a user applying forces thereto, the indicator 535 will tend to “snap” into the predetermined positions and will resist being positioned in between the predetermined positions.

In some examples, the guide frame 556 is integrally connected to (i.e., formed as part of the same unitary/monolithic body as) the base 583. In some examples, the guide frame 556 is formed separately from the base 583 and is later attached thereto. In some examples, the guide frame 556 is formed separately from the base 583 and is not attached thereto, with the guide frame 556 instead being loosely retained between the base 583 and the cover 532.

Although the illustrated cable 500 comprises electrical wires 541, in other examples a cable which utilizes optical fibers may have an identification unit which is substantially the same as the identification unit 530 illustrated in FIGS. 3-7. In some examples of such a cable having optical fibers, while an identification unit thereof may be substantially similar to the identification unit 530 described above, other aspects of the overall shape of the connector may differ from that of the connector 510. Moreover, the connector may include additional components not found in the connector 510, such as lenses, an optical multiplexer, or other optical components, or an optical transceiver, and may omit some of the components of the connector 510, such as the PCB 512 and pins 511.

Although five identifiers 536 are illustrated, in other examples a cable may have an identification unit which is substantially the same as the identification unit 530 except that it may have more or fewer than five identifiers (any number equal or greater than two). Furthermore, although the identifiers 536 are illustrated as the capital Roman letters A, B, C, D, and E, in other examples a cable may have an identification unit which is substantially the same as the identification unit 530 except that the identifiers thereof have a form other than the letters A, B, C, D, and E, such as: a different set of Roman letters (capital or lower-case), a set of letters from a non-Roman alphabet, a set of logograms or characters from another language, a set of numbers, a set of non-character symbols, etc. In addition, although the identifiers 536 are illustrated in the engraved configuration, in other examples a cable may comprise an identification unit which is substantially the same as the identification unit 530 except that the identifiers thereof have a raised (embossed) configuration in which they are formed by protrusions from the identifier carrying surface or a flat configuration in which they are co-planar with the identifier carrying surface. In examples in which the identifiers are co-planar with the identifier carrying surface, the identifiers may may be formed by printing or painting on the surface or by forming the portions of the body which correspond to the identifiers with a different color or shade of material than is used to form the surrounding portions of the body.

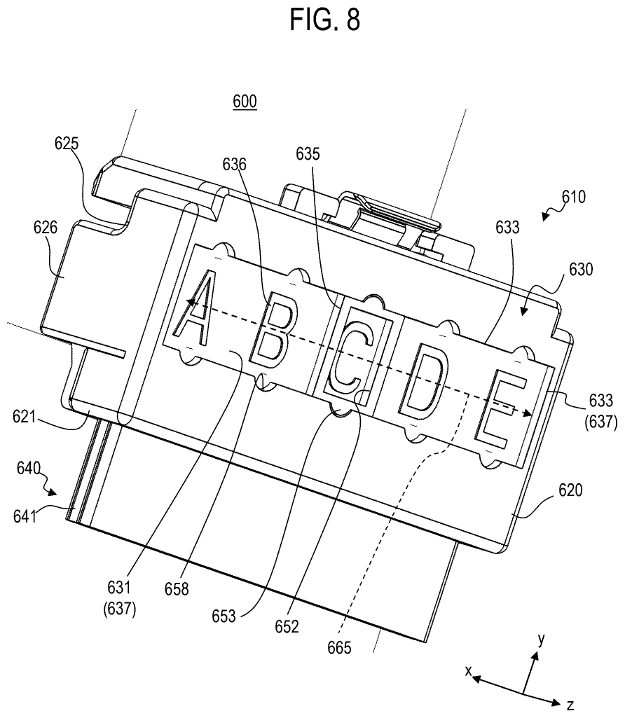

Turning now to FIG. 8, another example cable 600 will be described. The cable 600 is an implementation example of the cable 100. Accordingly, the cable 600 comprises components which correspond to (i.e., are implementation examples of) components of the cable 100 which were described above. Components of the cable 600 which correspond to components of the cable 100 will be given similar reference numbers herein, such as 110 and 610.

As shown in FIG. 8, the cable 600 comprises a wire assembly 640 and a connector 610 coupled to one end of the wire assembly 640. Only a portion of wire assembly 640 is illustrated. Cable 600 may also comprise another connector (not illustrated) connected to an opposite end (not illustrated) of the wire assembly 640. In some examples, this other connector may be identical in structure to the connector 610. In other examples, the other connector may be different from the connector 610.

The wire assembly 640 comprises a collection of electrical wires 641. The wire assembly 640 may be configured similarly to the wires assembly 540 described above, and thus duplicative description thereof is omitted.

The connector 610 comprises a connector housing 620, which is one example implementation of the connector housing 120 and which comprises a wire receiving portion 621, a pin holding portion 625, and anti-skew features 626. The wire receiving portion 621 comprises an opening through which the wires 641 are received into an internal cavity inside the connector housing 620, with the wires 641 extending through this internal cavity until they terminate at a set of pins (not visible) or at a PCB which carries such pins.

The connector 610 also comprises an identification unit 630, which is an example implementation of the identification unit 130. The identification unit 630 comprises identifiers 636, a movable indicator 635, and an indicator holder 637. The indicator holder 637 is made up of multiple parts which work together to hold the indicator 635, including an identifier carrying surface 631 and a recess 633. These components of the identification unit 630 will be described in turn below.

The identifiers 636 comprise visual representations of characters which are arranged in the recess 633 in the connector housing 620 in such a manner as to be visible to a user from a perspective above the connector 610 (i.e., higher along the z-axis). As shown in FIG. 8, the recess 633 is recessed from a top surface of the connector housing 620 and the identifier carrying surface 631 forms a bottom wall of the recess 633. The lateral walls of the recess 633 comprise stops 658. The identifiers 636 are formed in or on the identifier carrying surface 631. In the illustrated example, the recess 633 has a generally rectangular profile, but in other examples it may have any other shape.

In the illustrated example, the identifiers 636 comprise the capital Roman letters A, B, C, D, and E. The identifiers 636 are arranged in a line or row at predetermined locations which correspond to predetermined locations of the indicator 635. In the illustrated example, the identifiers 636 are formed as a series of protrusions which form segments of the characters, with the protrusions being protruded relative to the surrounding flat portions of the surface 631. This configuration in which the identifiers 636 are formed by protrusions may be referred to herein an “embossed configuration.” Note that “embossed” when used herein refers only to the phenomenon of the identifiers 636 having protruding structures as described, but this term is not intended to imply any limitation on the manner in which these structures are formed. More specifically, although embossing may sometimes refer, in other contexts, to forming designs specifically by pressing shapes into a surface, the usage of the term “embossed” herein does not imply or require such pressing. Instead, the embossed configuration of the identifiers 636 may be achieved through any of a variety of methods, such as: (1) by the removal of material from a top surface of the housing 620 to form both the identifiers 636 and the surface 631, such as through carving, milling, abrasive treatment (e.g., sandblasting), laser ablation, etc. (2) by forming the identifiers 363 as an integral feature of the surface 631 during an injection molding process which forms the connector housing 620, (3) by forming the identifiers 363 as an integral feature of the surface 631 during an additive manufacturing process which forms the connector housing 620, or (4) by any other method.

The movable indicator 635 is positioned in the aforementioned recess 633 on the surface 631 above the identifiers 636. As shown in FIG. 8, the movable indicator 635 comprises a generally rectangular frame which has an indicator window 652 in a middle thereof. Unlike the indicator 535, the indicator 635 does not have a tool opening. However, like the indicator 535, the indicator 635 comprises stop-engaging protrusions 653 protruding from the top and bottom sides thereof.

As shown in FIG. 8, the indicator window 652 is configured to surround or frame an identifier 636 when the movable indicator 635 is positioned adjacent thereto. In this manner, the indicator 635 visually indicates whichever identifier 636 is currently surrounded by the indicator window 652.

As shown in FIG. 8, the identifier carrying surface 631 is positioned below the indicator 635, while lateral walls of the recess 633 are positioned laterally around the indicator 635. Thus, these structures constrain the positions/motion of the indicator 635 in the-z direction and in the ±x- and ±y-directions. However, unlike the indicator 535, the indicator 635 does not necessarily have a structure positioned over it to constrain its motion in a +z direction.

The stop-engaging protrusions 653 are configured to engage with stops 658 to control a position of the indicator 635, in a manner similar to that described above in relation to stops 558. When the stops 658 are engaged with the protrusions 653, portions of the concave surface of the stops 658 laterally abut portions of the convex surface of the protrusions 653, and contact between these portions resist movement of the indicator 635 along the axis of motion 665. Friction between the protrusions 653 and stops 558 may also resist motion of the indicator 635 in the +z direction. Thus, while the indicator 635 may be movable in the +z direction with sufficient force applied thereto, the friction between the protrusions 653 and stops 558 may be sufficient to retain the indicator 635 in place in the face of shock, vibration, gravity, or the like.

In some examples, the movable indicator 635 may be movable in the following manner. Rather than sliding the movable indicator 635 against the surface 631 while it remains in the recess 633, in this example the indicator 635 may first be removed from the recess 633 before being moved along the axis 665. The indicator 635 may be removed from the recess 633 by a user applying a force to move the indicator 635 along the +z direction, sufficient to overcome any friction forces holding the indicator 635. Once the indicator 635 is removed from the recess 633, the stop-engaging protrusions 653 cease to engage with the stops 658, and therefore the indicator 635 is not free to be moved by the user along the axis 665. Once the indicator 635 is aligned with the desired identifier 636, the user may then insert the indicator 635 back into the recess 633 and in so doing may engage the protrusions 653 with the stops 658 which are located adjacent to the selected identifier 636. The stops 658 may then retain the indicator 635 in this position by friction, as previously described.

In some examples, friction may be sufficient to hold the indicator 635 in position. However, in some circumstances, it may be desired to have further assurances that the indicator 635 will not inadvertently become dislodged. Thus, in some examples, a transparent cover (not illustrated) may be added to the connector 610 covering the recess 633. In some examples, this cover may be mechanically connected to the connector 610 to allow for easy removal when desired, such as through snap-fit latches, screws, or other fastening mechanisms. In other examples, the cover may be permanently attached to the connector 610 once the indicator 635 has been positioned as desired, such as via adhesives, welding, heat staking, or the like. In other examples, instead of using a cover, the indicator 635 may be affixed in place using adhesives, such as by filling the recess 633 with a clear epoxy. Permanently affixing a cover or the indicator 635 may limit the ability to reconfigure the cables to indicate a different identifier 636 after a first configuration of the cable, but may still beneficially allow for the first configuration of the cable to be set to any of variable identifiers 636 as needed, such as during assembly of a system.

Although the illustrated cable 600 comprises electrical wires 641, in other examples a cable which utilizes optical fibers may have an identification unit which is substantially the same as the identification unit 630 illustrated in FIG. 8.

Although five identifiers 636 are illustrated, in other examples a cable may have an identification unit which is substantially the same as the identification unit 630 except that it may have more or fewer than five identifiers (any number equal or greater than two). Furthermore, although the identifiers 636 are illustrated as the capital Roman letters A, B, C, D, and E, in other examples a cable may have an identification unit which is substantially the same as the identification unit 630 except that the identifiers thereof have a form other than the letters A, B, C, D, and E, such as: a different set of Roman letters (capital or lower-case), a set of letters from a non-Roman alphabet, a set of logograms or characters from another language, a set of numbers, a set of non-character symbols, etc. In addition, although the identifiers 636 are illustrated in the embossed configuration, in other examples a cable may comprise an identification unit which is substantially the same as the identification unit 630 except that the identifiers thereof have the engraved configuration or a flat configuration in which they are co-planar with the identifier carrying surface.

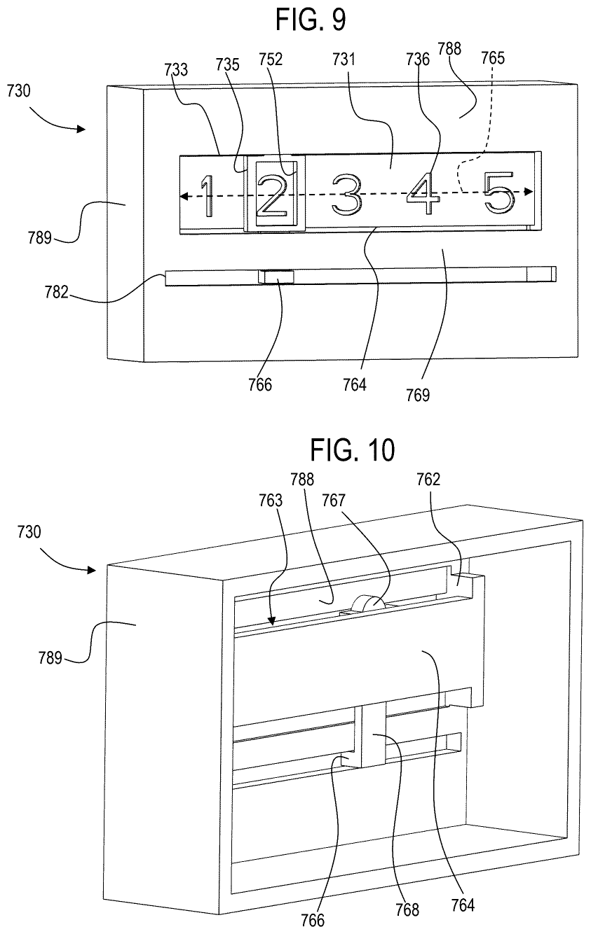

Turning now to FIGS. 9-10, an example identification unit 730 for a connector of a computer cable will be described. The cable identification unit 730 is an implementation example of the identification unit 130. Accordingly, the identification unit 730 comprises components which correspond to (i.e., are implementation examples of) components of the identification unit 130 which were described above. Components of the identification unit 730 which correspond to components of the identification unit 130 will be given similar reference numbers herein, such as 135 and 735.

The identification unit 730 may be used as part of a connector housing of a connector of a computer cable. The identification unit 730 comprises an outer housing 789 and an indicator 735 movably coupled thereto.

The outer housing 789 may be, in some cases, formed as an integral part of the connector housing of a connector. In other case, the outer housing 789 may be formed separately from the connector housing and may later be coupled thereto. The outer housing 789 comprises a top wall 788, and in the top wall 788 there are disposed a first aperture 733 and a second aperture 782, which are separated from one another by a divider 769.

Behind the first aperture 733 is a bridge 764. A top surface of the bridge 764 comprises an identifier carrying surface 731, on which identifiers 736 are arranged. The bridge 764 is spaced apart from the top wall 788 such that there is a gap 763 between the surface 731 and the top wall 788. The bridge 764 is coupled to the outer housing 789 by supports 762 (only one is visible in FIG. 10, but another one may be disposed on an opposite side of the bridge 764).

The indicator 735 is disposed in the gap 763 between the surface 731 and the top wall 788. The indicator 735 comprises a window 752 and an actuation tab 766. The actuation tab 766 is coupled to the window 752 by leg 768. The indicator 735 also comprises a retention tab 767, which protrudes from a top side of the window 752. The retention tab 767 sits below the top wall 788. The leg 768 sits below the divider 769. Thus, the indicator 735 is clamped or sandwiched between the bridge and the top wall 788, thereby retaining or attaching the indicator 735 to the outer housing 789. The indicator 735 is slidable relative to the outer housing 789 along the axis of motion 765.

The actuation tab 766 of the indicator 735 protrudes from the leg 768 forwards through the second aperture 782. This provides a convenient structure which a user can manually apply forces to in order to cause the indicator 735 to slide along axis 765. For example, a user may be able to apply their finger directly to the actuation tab 766, or may insert a tool into the aperture 782 to push against the actuation tab 766.

In the illustrated example, the identifiers 736 are shown as numbers formed in the engraved configuration. However, it should be understood that in other examples an identification unit substantially the same as the identification unit 730 may be used except that the identifiers may be letters, symbols, or other identifiers and/or may have other forms such as an embossed configuration or a flat configuration.

In the illustration, the outer housing 789 is shown as being completely hollow with no rear wall. However, this is merely for convenience of illustration, and in practice the outer housing 789 could be filled-in (solid) and/or could have a back wall. The region in which the indicator 735 moves may need to be free of material, as shown, but other regions of the outer housing 789 do not necessarily need to be open and may be filled if desired. Furthermore, in the illustration the outer housing 789 is shown as having the shape of a rectangular box (rectangular prism), but in practice the outer housing 789 can have any convenient shape. In particular, in examples in which the outer housing 789 is formed as part of the connector housing of a connector, the outer housing 789 may take on whatever shape the connector has.

It is to be understood that both the general description and the detailed description provide examples that are explanatory in nature and are intended to provide an understanding of the present disclosure without limiting the scope of the present disclosure. Various mechanical, compositional, structural, electronic, and operational changes may be made without departing from the scope of this description and the claims. In some instances, well-known circuits, structures, and techniques have not been shown or described in detail in order not to obscure the examples. Like numbers in two or more figures represent the same or similar elements.

In addition, the singular forms “a”, “an”, and “the” are intended to include the plural forms as well, unless the context indicates otherwise. Moreover, the terms “comprises”, “comprising”, “includes”, and the like specify the presence of stated features, steps, operations, elements, and/or components but do not preclude the presence or addition of one or more other features, steps, operations, elements, components, and/or groups. Components described as coupled may be electronically or mechanically directly coupled, or they may be indirectly coupled via one or more intermediate components, unless specifically noted otherwise. Mathematical and geometric terms are not necessarily intended to be used in accordance with their strict definitions unless the context of the description indicates otherwise, because a person having ordinary skill in the art would understand that, for example, a substantially similar element that functions in a substantially similar way could easily fall within the scope of a descriptive term even though the term also has a strict definition.

And/or: Occasionally the phrase “and/or” is used herein in conjunction with a list of items. This phrase means that any combination of items in the list—from a single item to all of the items and any permutation in between—may be included. Thus, for example, “A, B, and/or C” means “one of {A}, {B}, {C}, {A, B}, {A, C}, {C, B}, and {A, C, B}”.

Elements and their associated aspects that are described in detail with reference to one example may, whenever practical, be included in other examples in which they are not specifically shown or described. For example, if an element is described in detail with reference to one example and is not described with reference to a second example, the element may nevertheless be claimed as included in the second example.

Unless otherwise noted herein or implied by the context, when terms of approximation such as “substantially,” “approximately,” “about,” “around,” “roughly,” and the like, are used, this should be understood as meaning that mathematical exactitude is not required and that instead a range of variation is being referred to that includes but is not strictly limited to the stated value, property, or relationship. In particular, in addition to any ranges explicitly stated herein (if any), the range of variation implied by the usage of such a term of approximation includes at least any inconsequential variations and also those variations that are typical in the relevant art for the type of item in question due to manufacturing or other tolerances. In any case, the range of variation may include at least values that are within ±1% of the stated value, property, or relationship unless indicated otherwise.

Further modifications and alternative examples will be apparent to those of ordinary skill in the art in view of the disclosure herein. For example, the devices and methods may include additional components or steps that were omitted from the diagrams and description for clarity of operation. Accordingly, this description is to be construed as illustrative only and is for the purpose of teaching those skilled in the art the general manner of carrying out the present teachings. It is to be understood that the various examples shown and described herein are to be taken as exemplary. Elements and materials, and arrangements of those elements and materials, may be substituted for those illustrated and described herein, parts and processes may be reversed, and certain features of the present teachings may be utilized independently, all as would be apparent to one skilled in the art after having the benefit of the description herein. Changes may be made in the elements described herein without departing from the scope of the present teachings and following claims.

It is to be understood that the particular examples set forth herein are non-limiting, and modifications to structure, dimensions, materials, and methodologies may be made without departing from the scope of the present teachings.

Other examples in accordance with the present disclosure will be apparent to those skilled in the art from consideration of the specification and practice of the invention disclosed herein. It is intended that the specification and examples be considered as exemplary only, with the following claims being entitled to their fullest breadth, including equivalents, under the applicable law.

What is claimed is:

1. A computer cable comprising:
a wire assembly comprising one or more electrical wires or optical fibers; and
a connector coupled to an end of the wire assembly, the connector comprising:
a connector housing;
a set of pins held by the connector housing and electrically connected to or optically coupled with the wire assembly; and
an identification unit formed in part by the connector housing and comprising:
a set of identifiers formed on or in the connector housing; and
a movable indicator movably coupled to the connector housing and configured to be movable to selectively visually indicate any identifier of the set of identifiers.

2. The computer cable of claim 1,
wherein the set of identifiers are integrally formed into a surface of the connector housing in an engraved configuration or in an embossed configuration.

3. The computer cable of claim 1,
wherein the set of identifiers are printed on a surface of the connector housing.

4. The computer cable of claim 1,
wherein the indicator comprises a window and is configured to selectively visually indicate an identifier of the set of identifiers by the window surrounding the identifier.

5. The computer cable of claim 1,
wherein the indicator comprises a protrusion or marking and is configured to selectively visually indicate an identifier of the set of identifiers by the protrusion or marking being aligned with the identifier.

6. The computer cable of claim 1,
wherein the indicator is configured to selectively visually indicate an identifier of the set of identifiers by the indicator being aligned with the identifier.

7. The computer cable of claim 1,
wherein the connector housing comprises a recess and an identifier carrying surface forming a base of the recess, the identifiers being formed on or in the identifier carrying surface; and
wherein the indicator is disposed within the recess.

8. The computer cable of claim 7,
wherein the connector housing comprises a base and a cover connected to the base, wherein the identifier carrying surface comprises a top surface of the base and the recess is formed, in part, by an aperture through the cover disposed over the identifier carrying surface.

9. The computer cable of claim 8,
wherein the connector comprises an indicator holder comprising the identifier carrying surface, the cover, and a guide frame,
wherein the guide frame comprises two side portions and two crossmembers connected together and surrounding the identifiers,
wherein the crossmembers comprise stops configured to engage with the indicator to hold the indicator in predetermined positions respectively corresponding to the identifiers, and
wherein the indicator comprises stop-engaging protrusions configured to engage with the stops to hold the indicator in the predetermined positions.

10. The computer cable of claim 9,
wherein the indicator is movable between the predetermined positions by sliding the indicator along the crossmembers and elastically deforming the indicator and/or the crossmembers.

11. The computer cable of claim 9,
wherein indicator comprises:
a window configured to, on condition of the indicator being in one of the predetermined positions, surround one of the identifiers corresponding to the predetermined position; and
a tool opening configured to receive a tool to facilitate movement of the indicator.

12. The computer cable of claim 11,
wherein the connector comprises a transparent windowpane disposed in the recess and covering the identifier and the window of the indicator,
wherein the connector comprises a slot between an edge of the windowpane and an edge of the aperture, the slot positioned over the tool opening of the indicator.

13. The computer cable of claim 7,
wherein the recess is recessed from a top surface of the connector housing and lateral wall of the recess comprises stops configured to engage with the indicator to hold the indicator at predetermined positions respectively corresponding to the identifiers.

14. The computer cable of claim 1,
wherein the connector housing comprises a top wall, an aperture in the top wall, and a bridge disposed below the top wall, and
wherein the indicator is disposed between the bridge and the top wall such that the indicator is slidable along the bridge, and
wherein the identifiers are formed in or on a surface of the bridge.

15. An information processing system, comprising:
a chassis;
a system board supported by the chassis and comprising a processor and a system board connector;
a peripheral component comprising a peripheral component connector; and
a computer cable communicably coupling the peripheral component to the system board, the computer cable comprising:
a wire assembly comprising one or more electrical wires or optical fibers;
a first cable connector coupled to a first end of the wire assembly and connected to the system board connector; and
a second cable connector coupled to a second end of the wire assembly and connected to the peripheral component connector,
wherein each of the first and second cable connectors comprises:
a connector housing;
a set of pins held by the connector housing and electrically connected to or optically coupled with the wire assembly; and
an identification unit formed in part by the connector housing and comprising:
a set of identifiers formed on or in the connector housing; and
a movable indicator movably coupled to the connector housing and configured to be movable to selectively visually indicate any identifier of the set of identifiers.

16. The information processing system of claim 15,
wherein the movable indicator of the first cable connector is set to indicate a first identifier and the movable indicator of the second cable connector is set to indicate a second identifier different than the first identifier.

17. The information processing system of claim 15, comprising:
a plurality of peripheral components including the peripheral component, each of the peripheral components comprising a peripheral component connector; and
a plurality of computer cables including the computer cable;
wherein the system board comprises a plurality of system board connectors including the system board connector;
wherein the computer cables respectively connect the peripheral components to the system board connectors;
wherein each of the computer cables comprises two cable connectors, wherein each of the cable connectors comprises a connector housing and an identification unit comprising:
a set of identifiers formed on or in the connector housing; and
a movable indicator movably coupled to the connector housing and configured to be movable to selectively visually indicate any identifier of the set of identifiers; and
wherein the movable indicators of the cable connectors of the computer cables are each set to indicate an identifier which corresponds to an identifier of the peripheral component connector or the system board connector to which the respective cable connector is connected.

18. A method of assembling or servicing an information processing system, comprising:
providing an information processing system comprising multiple system board connectors of a system board, and multiple peripheral component connectors of one or more peripheral components;
connecting a first cable connector of a computer cable to a first peripheral component connector of the peripheral component connectors; and
connecting a second cable connector of the computer cable to a first system board connector of the system board connectors,
wherein each of the first cable connector and the second cable connector comprises a connector housing and an identification unit comprising a plurality of identifiers formed in or on the connector housing and an indicator movably coupled to the connector housing to selectively indicate any identifier of the plurality of identifiers.

19. The method of claim 18, comprising:
selecting the first peripheral component connector, out of the peripheral component connectors, for connection to the first cable connector based on a first identifier indicated by the indicator of the identification unit of the first cable connector; and
selecting the first system board connector, out of the system board connectors, for connection to the second cable connector based on a second identifier indicated by the indicator of the identification unit of the second cable connector.

20. The method of claim 18, comprising:
moving the indicator of the identification unit of the first cable connector and/or the indicator of the identification unit of the second cable connector to change which identifier is indicated by the indicator.
